(19) United States
(12) Patent Application Publication
(10) Pub. No.: US 2005/0229917 A1
(43) Pub. Date: Oct. 20, 2005

(54) Gas grill

(76) Inventors: Mark T. Profitt, Greenville, TN (US); Scott Dellinger, Georgetown, KY (US); Larry Huff, Greenville, TN (US); Robert B. Holben, Roswell, GA (US)

Correspondence Address: Luke Anderson;The Proscenium, McGuireWoods LLP, Suite 2100, 1170 Peachtree Street, NE, Atlanta, GA, 30309, US

(21) Appl. No.: 11/091,196

(22) Filed: Mar. 28, 2005

Related U.S. Application Data
(60) Provisional application No. 60/557,437, filed on Mar. 29, 2004.

(51) Int. Cl. F24B 3/00; A47J 37/00

(52) U.S. Cl. 126/25 R; 126/41 R

(57) ABSTRACT

The present invention is directed toward an improved barbeque grill that addresses the problems left unsolved by the barbeque grills of the prior art. More specifically the present invention relates to improvements to the hinge used to connect the grill hood to the grill cooking body or bowl, and improvements to the grill's wheel assembly. Accordingly, an embodiment of the present invention is directed to a grill having a hinge comprising at least one integral post and at least one mating tab. Another embodiment is directed to a grill having a pair of wheels and a support foot that prevents the wheels from engaging the ground when the grill is stationary. Another embodiment of the present invention also relates to a grill comprising improved interchangeable table platforms on the sides of the grill cooking body, having at least one external burner incorporated therein. Finally, another embodiment of the present invention relates to a grill comprising an improved grease pan that is integrated into the underside of the grill control panel making the grease pan easily accessible from the front of the grill.

### CLAIM OF PRIORITY

This invention claims priority to co-pending U.S. Provisional Application No. 60/557,437 filed on Mar. 29, 2004.

### FIELD OF THE INVENTION

The present invention relates generally to barbecue grills. More specifically the present invention relates to improvements made to the design and usability of gas grills due to an improved hinge used to connect the hood to the grill body, an improved wheel assembly and support foot, improved interchangeable table platforms on the side of the grill cooking body, and an improved grease pan integrated into the underside of the control panel that can easily be accessed from the front of the grilling unit.

### BACKGROUND

Grilling is an all American past time. Accordingly, it is no surprise that barbeque grills are well known in the prior art. Yet, many problems exist with the prior art grills. For example many such grills include heavy lids that must be properly secured to the grill body. Such lids are usually secured via some sort of hinge mechanism. As such, the hinge connecting the hood to the grill body is a critical component of each grill, which if it fails due to repeated use, corrosion, or other malfunction, can render the grill unusable, or worse, cause injury to the user.

Due to space constraints and various safety factors, most grills also need to be moved from time to time. In order to accommodate such movement, many grills have wheels to make movement easy. Wheels are also placed on grills to make them portable. In fact, outdoor barbecue cooking has increasingly expanded from the back yard to locations such as tailgate parties, beach outings, and picnic outings requiring the user to bring the grill with them. At the same time, a grill with wheels can also be accidentally moved if care is not used to secure it. Such accidental movement of the grill poses a hazard to the grill itself, not to mention possible dangers to the user.

In order to provide a more complete outdoor cooking experience, outdoor grills often have more than one cooking surface. For example, external burners are quite common to allow for cooking methods which require heating foods in a container such as a pot or pan. Accordingly, these external burners are usually provided in a fixed location outside of, and adjacent to, the primary grilling surface. Because the external burner is fixed, however, the extra burner cannot be moved to accommodate the desires of the user.

Likewise, many gas grills include pans to catch grease dripping from the food during cooking. Generally, the grease pan is located beneath a hole in the grill body, and behind the control panel, to catch grease as it drips from the grilling surface and runs to the bottom of the grill body. When the grease pan fills up with grease, it must be emptied and cleaned. Many of the prior art grease pans are hard to use, however, because they can only be accessed from the back of the grill, which is not always easy to get to. As such, the grill usually has to be moved before the grease pan can be accessed.

Accordingly, a need exists for an improved barbecue grill that addresses these and other problems that are not solved by the barbecue grills of the prior art. It is to such an improved barbecue grill that the present invention is directed.

### SUMMARY OF THE INVENTION

Generally, the present invention addresses the problems left unsolved by the barbeque grills of the prior art. More specifically the present invention relates to improvements to the hinge used to connect the grill hood to the grill cooking body or bowl, and improvements to the grill's wheel assembly. The present invention also relates to improved interchangeable table platforms on the sides of the grill cooking body. Finally, the present invention relates to an improved grease pan that is integrated into the underside of the grill control panel making the grease pan easily accessible from the front of the grill.

Accordingly, an aspect of the present invention includes a barbecue grill comprising a grill hood attached to the grill body or bowl via an improved hinge mechanism. An embodiment of the barbecue grill comprises a grill body, a grilling surface carried by the grill body, a support base attached to the grill body, and a hood pivotally attached to the grill body by at least one hinge, wherein the hinge comprises at least one integral post and at least one corresponding mating tab.

Another aspect of the present invention includes a barbecue grill comprising a support foot that prevents the wheels of the grill from contacting the ground when the grill is resting, or stationary, in a horizontal position, yet allows the wheels to contact the ground when one side of the grill is lifted at an angle to the horizontal. An embodiment of the barbecue grill comprises a grill body, a grilling surface carried by the grill body, a support base attached to the grill body, at least one pair of wheels located on the support base, and at least one support foot located proximate to the wheels, wherein the support foot prevents the wheels from engaging the ground when the grill is in a stationary horizontal position, while allowing the wheels to engage the ground when one side of the grill is lifted at an angle to the horizontal.

Yet another aspect of the present invention includes a barbecue grill comprising interchangeable side platforms that attach to the grill's cooking body or bowl, wherein an external burner is provided on at least one of the side platforms so that the external burner may be placed on either the right or left side of the grill depending on user preference. An embodiment of the barbecue grill comprises a grill body, a grilling surface carried by the grill body, a support base attached to the grill body, a pair of interchangeable side platforms removably attached to the side portions of the grill body, and at least one side burner incorporated into one of the interchangeable side platforms, wherein the side burner and accompanying side platform may be detached from one side of the grill body and reattached to the other side of the grill body.

Still another aspect of the present invention includes a barbecue grill comprising a grease pan that is integrated into the underside of the grill control panel making it accessible from the front of the grill. An embodiment of the barbecue grill comprises a grill body, a grilling surface carried by the grill body, a support base attached to the grill body, a control panel located on the front of the grill for controlling the operation of the grilling surface of the grill, and a grease pan removably incorporated into the underside of the control panel for capturing grease from the grill body.

Other aspects of the present invention will become apparent upon reading the detailed description provided herein below.

### BRIEF DESCRIPTION OF THE DRAWINGS

The present invention may take form in various components and arrangements of components and parts. Accordingly, the drawings are only for illustrating the preferred embodiments of the present invention and are not to be construed as limiting the invention in any way.

FIG. 1 is a perspective view of an embodiment of the present invention;

FIG. 2 is a front view of an embodiment of the present invention;

FIG. 3 is a right side view of an embodiment of the present invention;

FIG. 4 is a left side view of an embodiment of the present invention;

FIG. 5 is a back view of an embodiment of the present invention;

FIG. 6 is a top view of an embodiment of the present invention;

FIG. 7 is a close up view illustrating the control panel and grease pan of another embodiment of the present invention.

FIG. 8 is an illustration of the hinge assembly of yet another embodiment of the present invention; and

FIG. 9 is a close up view illustrating the wheel assembly and support foot of still another embodiment of the present invention.

### DETAILED DESCRIPTION

As used herein, the term “grill” is meant to encompass outdoor cooking grills, including, but not limited to, charcoal grills, gas grills, electric grills, and solar grills, of any shape that have an upwardly open grill body or bowl structure supporting a grilling surface. The terms “front”, “rear”, and “sides” as used herein relative to the grill body, or bowl, are for describing relative positions and are not meant as a limitation. For example, round grills might not have an actual front, rear, or sides, and for other shapes it would be well within the ability of one of ordinary skill in the art to rotationally reposition the grill body relative to the other components of the grill. It must also be noted that, as used in this disclosure and the appended claims, the singular forms “a”, “an”, and “the” include plural referents unless the context clearly dictates otherwise.

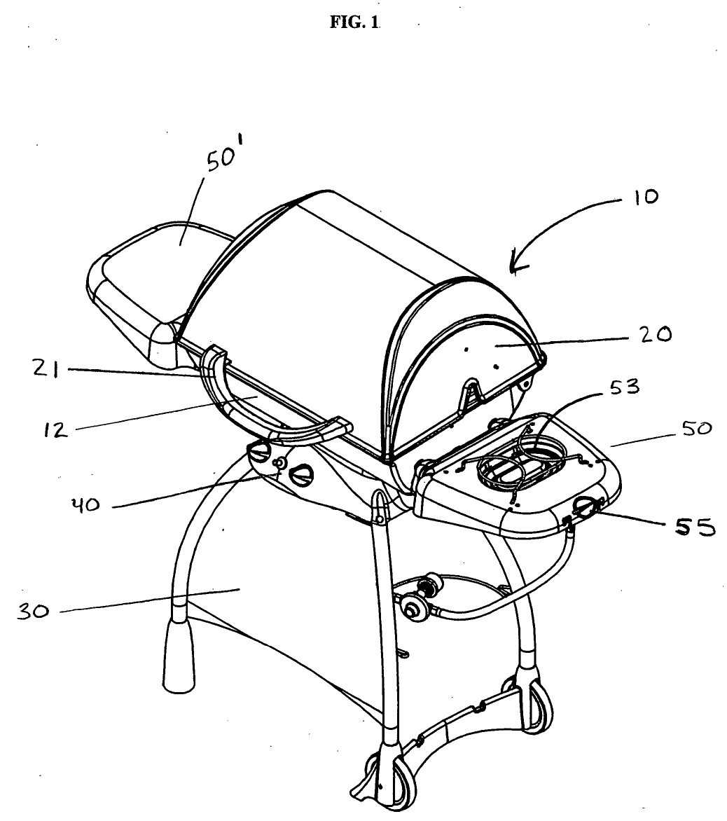

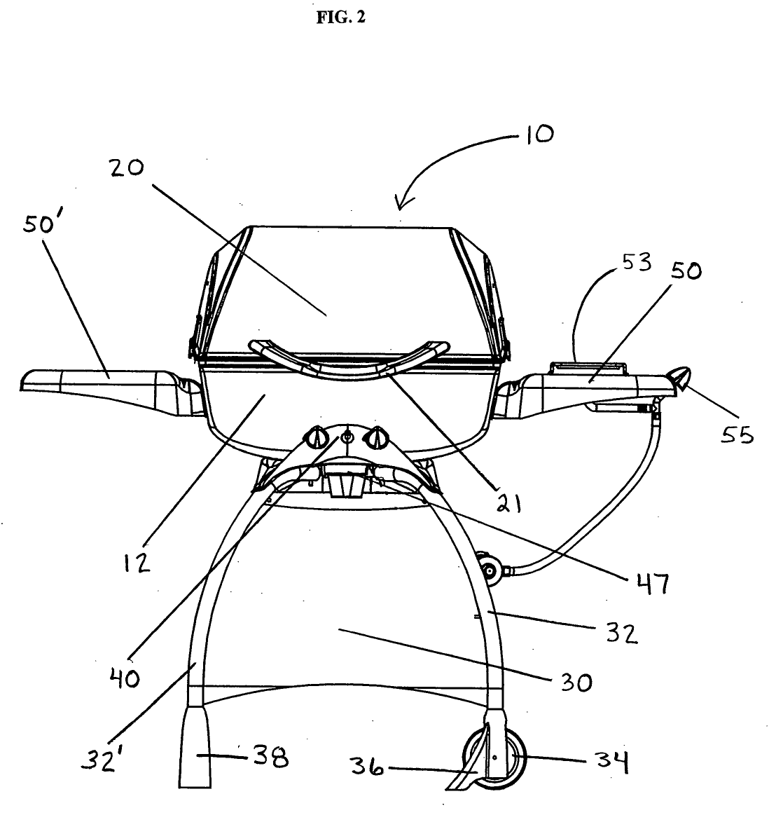

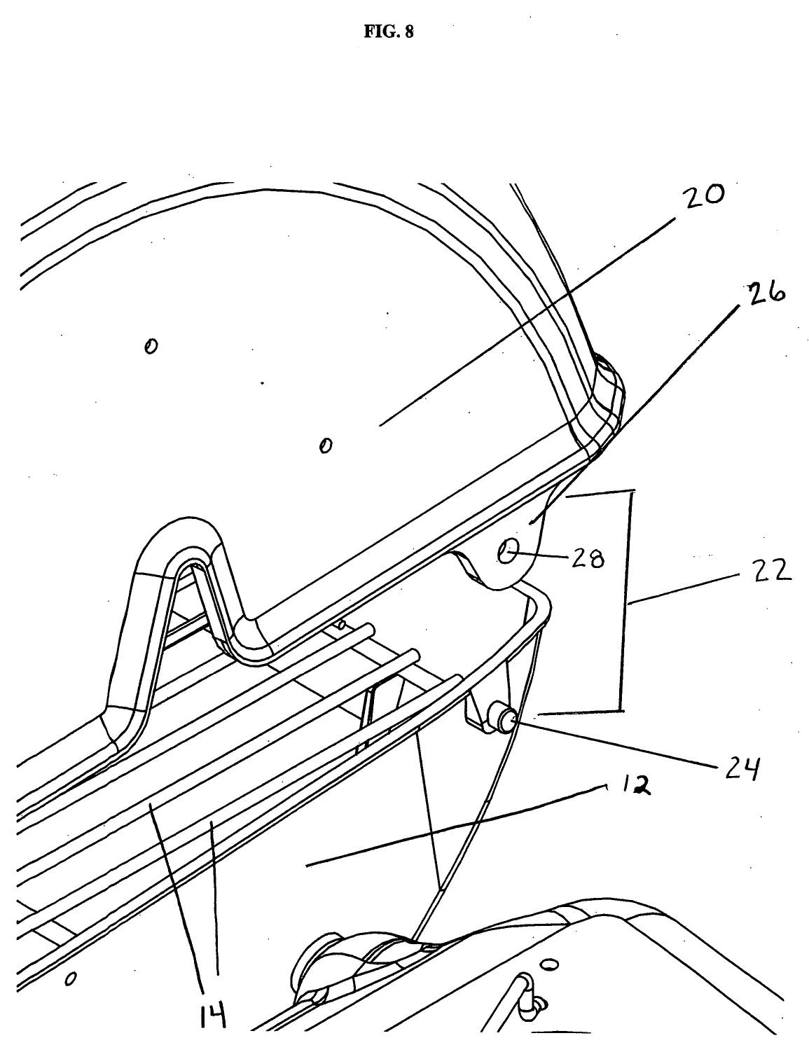

Referring now in detail to the Figures, there is shown in FIGS. 1 and 2 perspective and front views of a preferred embodiment of a barbecue grill, generally designated by reference numeral 10, constructed in accordance with the teachings of the present invention. In the embodiment illustrated, grill body 12 is shown as generally rectangular in shape with a rounded bowl or bottom, but may also be any other shape used for grills, such, as, but not limited to, square shapes, circular shapes, and combinations thereof. Grill body 12 also includes a primary grilling surface 14 (partially shown in FIG. 8), a lid or hood 20, support member 30, control panel 40, and side platforms 50 and 50′. Side burner 53 is incorporated into side platform 50 along with its own control knob(s) 55.

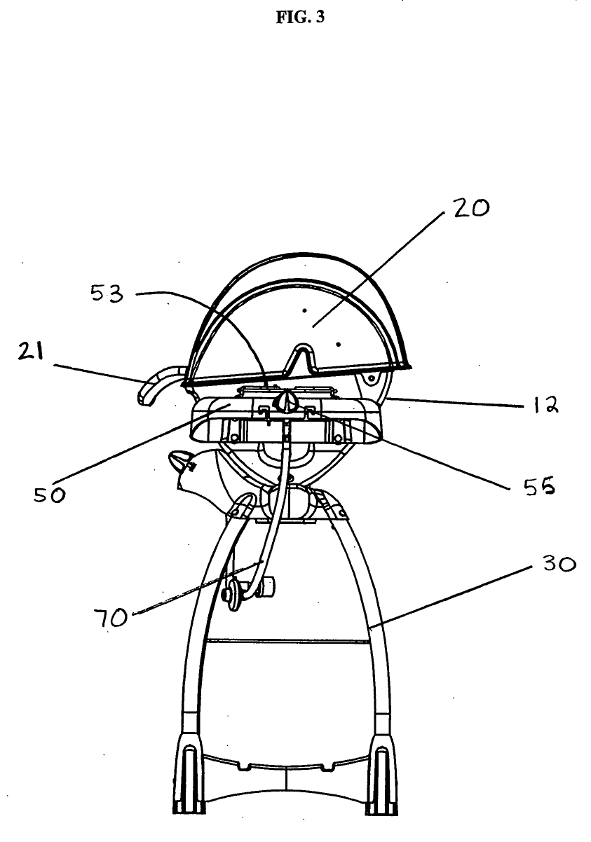

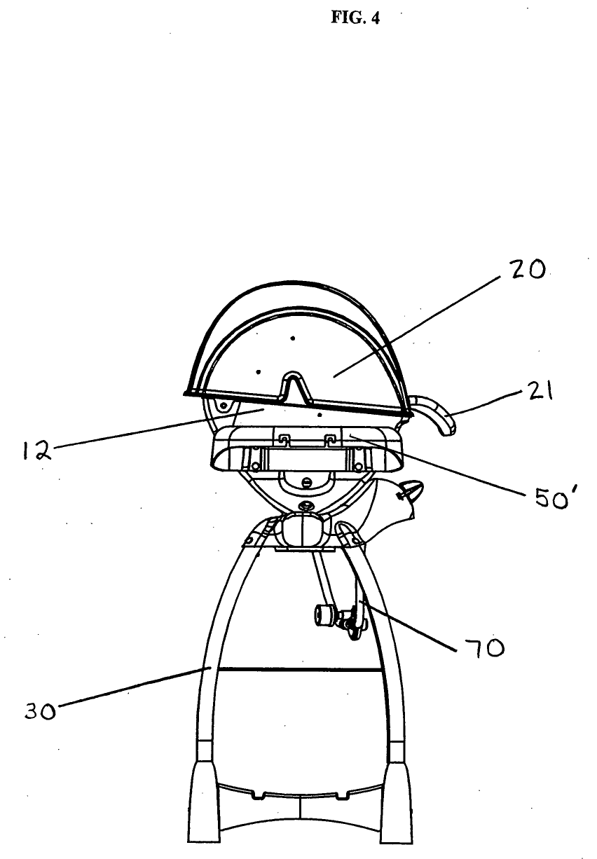

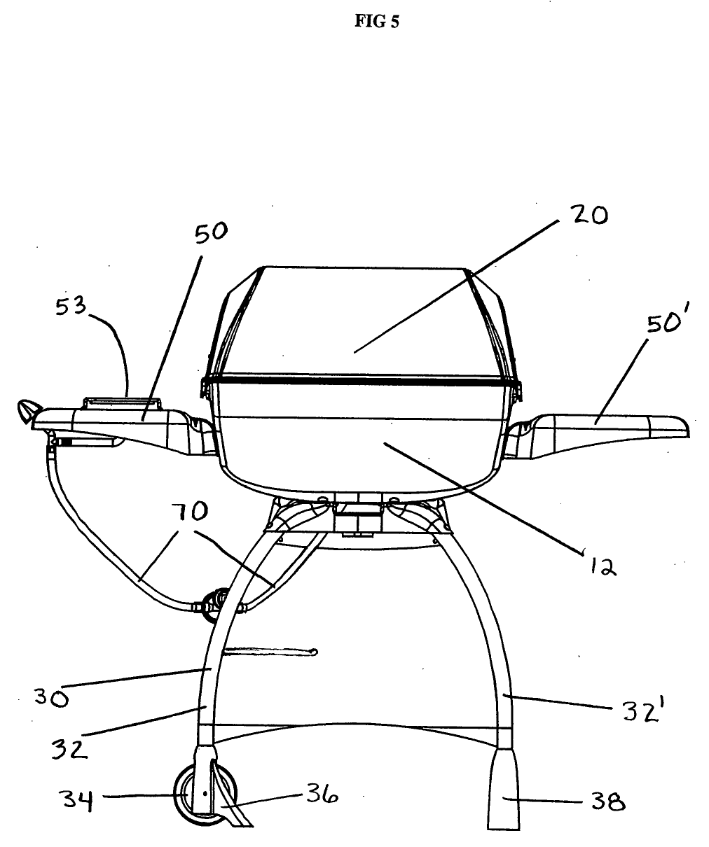

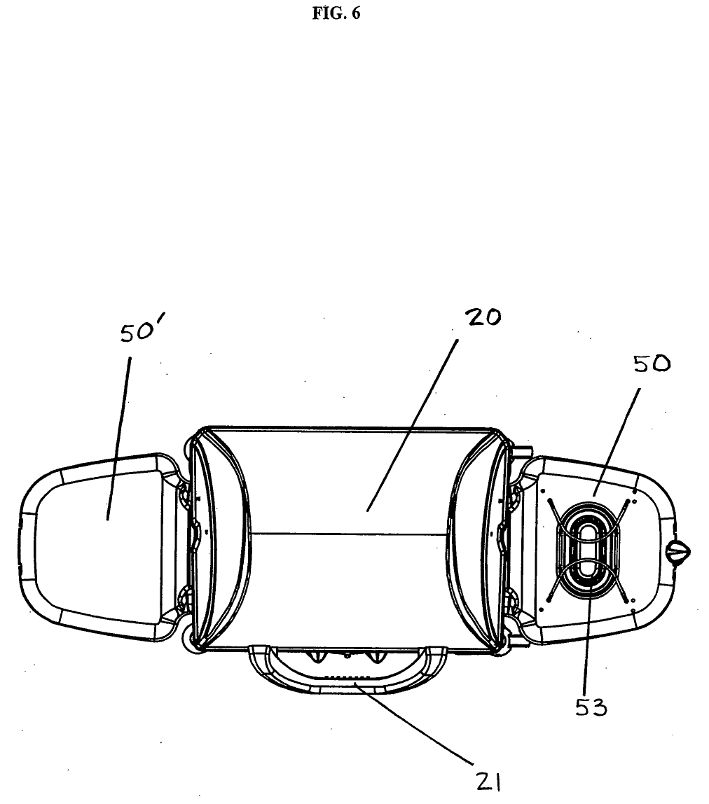

As additionally illustrated in FIGS. 3, 4, 5 and 6, an embodiment of the present invention includes interchangeable side platforms 50 and 50′ that can be placed on either the left or right side of the grill body 12. At least one external side burner 53 is incorporated into side platform 50. Alternatively, a plurality of side burners may be provided. This gives the user the choice of placing side burner 53 on either the left or right side of the grill 10 or removing it altogether. This has been accomplished by designing the side platform 50 with side burner 53 so that the controls 55 for the side burner are also located on respective side platform 50. Dual fuel line 70 is also included to supply fuel to both side burner 53 and to the primary grilling surface of grill body 12. Dual fuel line 70 is additionally connected to a fuel source such as a propane tank (not shown). Thus, the control knob(s) 55 for the side burner 53 is/are accessible no matter which side of the grill that side burner 53 is located on. The cooking surface of the side burner 53 (grid for a cooking pot or pan) is also located on side platform 50 so that it is accessible no matter which side of the grill side burner 53 is located on. In should be noted that if grill 10 is an electric grill, fuel line 70 is not needed and side burner 53 and the primary grilling surface 14 (partially shown in FIG. 8) of grill body 12 comprise electric heating elements such as those generally known in the art.

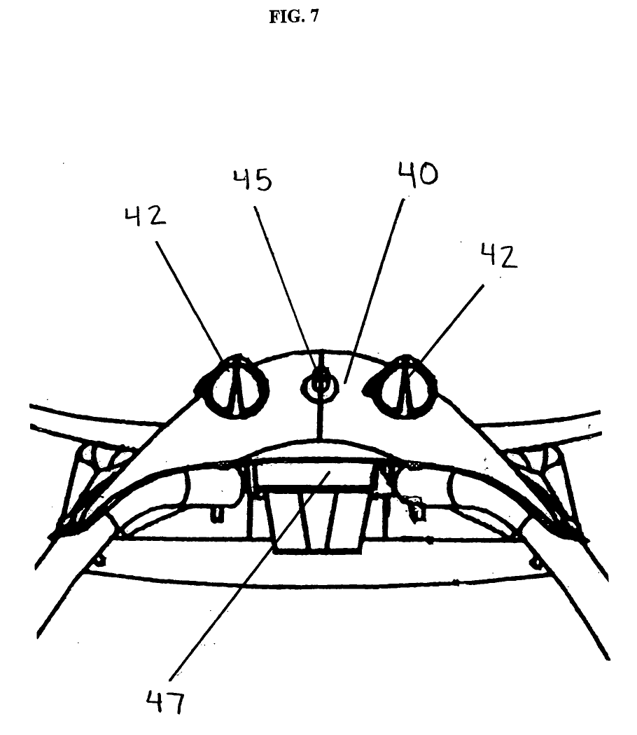

As shown in FIGS. 1, 2, and 7, an embodiment of the present invention also comprises a control panel 40 located on the front of grill 10. Control panel 40 includes control knobs 42, and optionally, igniter or starter 45. According to another embodiment of the present invention, the underside of control panel 40 is specially formed to hold a small grease pan 47 to catch any grease dripping from the grill body 12. This may be accomplished by providing an integral slot in the underside of control panel 40 for grease pan 47 to slide into, or by any other attachment means known in the art. Not only does this offer a more convenient and secure location to place the grease pan on the grill, it also helps prevent accidental spillage of grease. The location of grease pan 47 allows the grease pan to be easily removed from the front of the grill without requiring the user to move the grill or walk behind the grill.

Another aspect of the present invention includes an improved hinge that is simple yet effective. Referring to another embodiment shown in FIG. 8, an improved hinge 22 between the hood 20 and grill body 12 is formed by molding an integral post 24 on each left and right side of grill body 12. Preferably, grill body 12 is an aluminum die cast bowl. It will be recognized by those having skill in the art, however, that grill body 12 may be made of other materials customary to barbecue grills such as cast iron, stainless steel, or many other materials that are not listed here. The hood 20 has corresponding mating tabs 26 formed with a hole 28 integrally molded into each left and right side. Tabs 26 further incorporate a tapered lead-in to accept the posts 24 from the grill body 12. Alternatively, the posts may be located on the hood and the corresponding mating tabs located on the grill body. To assemble hood 20 to grill body 12, hood 20 is placed above grill body 12 in the closed position and pressed downward onto the top surface of grill body 12 where the posts 24 on the left and right side of grill body 12 flex slightly inward allowing enough room for hood 20 to move down and the posts 24 to snap outward into the tabs 26 on hood 20. The assembly is complete and the hood can be opened by lifting the front of the hood upward. In another embodiment (not shown), the integral post(s) is/are located on the rear of the bowl with the corresponding mating tab(s) located on the rear of the hood.

A handle 21 (FIGS. 1, 2, 3, 4, and 6) may also be included on the hood 12. Handle 21 is conveniently located in such an area as to allow the handle to maintain a cooler temperature. The grip area of handle 21 is located forward of grill 10 and slightly below the concentrated area of heat being emitted from the primary grilling surface (not shown) allowing handle 21 to remain at a cooler temperature.

Another aspect of the present invention comprises a wheeled leg assembly utilizing a support foot that prevents the grill from moving when in the horizontal sitting position. As shown in the embodiments in FIGS. 2, 5, and 9, support base 30 comprises two sets of support legs 32 and 32′. Support legs 32 and 32′ may additionally include a cross-bar or panel connecting each set of legs to one another for additional structural support. At least one pair of wheels 34 are provided on support legs 32 along with foot support 36. When the opposite end of the grill 10 is lifted from the ground at an angle to the horizontal, support foot 36 is also lifted and the wheels 34 contact the ground allowing the grill 10 to be rolled from one place to another. Thus, grill 10 rolls when tilted, but rests on support foot 36 when positioned near an upright, stationary position.

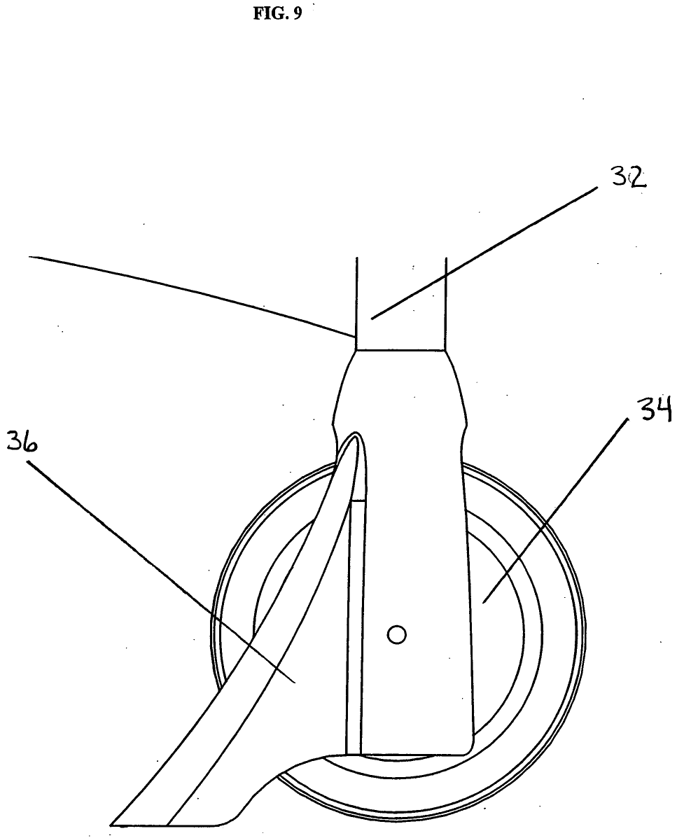

Each individual wheeled leg 32 may have its own support foot 36, or a single support foot spanning the width between the wheels may be used. Preferably, support foot 36 is incorporated into the wheel assembly as seen in FIG. 9. Support foot 36, however, may also be a separate part attached to support legs 32 or may be an integral extension of support legs 32. In a preferred embodiment, the support legs 32 and 32′ are formed from cold rolled commercial tubing. The support legs 32′ which are opposite wheeled legs 32 may also include end caps 38.

Any one of the aforementioned improvements may be utilized individually, or in combination, with the various embodiments of the present invention. Numerous characteristics and advantages have been set forth in the foregoing description, together with details of structure and function of the preferred embodiments of the present invention, the novel features of which are pointed out in the appended claims. The disclosure, however, is illustrative only, and changes may be made in detail, especially in matters of shape, size, and arrangement of parts, within the principle of the present invention, to the full extent indicated by the broad general meaning of the terms in which the appended claims are expressed.

1. A barbecue grill comprising:
a grill body having front, rear, and side portions;
a grilling surface carried by said grill body;
a support base attached to said grill body; and
a hood pivotally attached to said grill body by at least one hinge;
wherein said hinge comprises at least one integral post and at least one corresponding mating tab.

2. The barbecue grill of claim 1 further comprising:
a pair of interchangeable side platforms removably attached to the side portions of said grill body; and
at least one side burner incorporated into one of said interchangeable side platforms;
wherein said side burner and accompanying side platform may be detached from one side of said grill body and reattached to the other side of said grill body.

3. The barbecue grill of claim 2, wherein said side platform having said side burner incorporated therein further comprises at least one control knob for controlling the operation of said side burner.

4. The barbecue grill of claim 1 further comprising:
at least one pair of wheels located on said support base; and
a support foot located proximate to said wheels;
wherein said support foot prevents said wheels from engaging the ground when said grill is in a sitting horizontal position, but allows said wheels to engage the ground when one side of the grill is lifted at an angle to the horizontal.

5. The barbecue grill of claim 1 further comprising:
a control panel located on the front of said grill for controlling the operation of said grilling surface of said grill; and
a grease pan removably incorporated into the underside of said control panel for capturing grease from said grill body.

6. A barbecue grill comprising:
a grill body having front, rear, and side portions;
a grilling surface carried by said grill body;
a support base attached to said grill body;
a control panel located on the front of said grill for controlling the operation of said grilling surface of said grill; and
a grease pan removably incorporated into the underside of said control panel for capturing grease from said grill body.

7. The barbecue grill of claim 6 further comprising:
a pair of interchangeable side platforms removably attached to the side portions of said grill body; and
at least one side burner incorporated into one of said interchangeable side platforms;
wherein said side burner and accompanying side platform may be detached from one side of said grill body and reattached to the other side of said grill body.

8. The barbecue grill of claim 7, wherein said side platform having said side burner incorporated therein further comprises at least one control knob for controlling the operation of said side burner.

9. The barbecue grill of claim 6 further comprising a hood pivotally attached to said grill body by at least one hinge, wherein said hinge comprises a pair of integral posts and a pair of corresponding mating tabs.

10. The barbecue grill of claim 6 further comprising:
at least one pair of wheels located on said support base; and
a support foot located proximate to said wheels;
wherein said support foot prevents said wheels from engaging the ground when said grill is in a sitting horizontal position, but allows said wheels to engage the ground when one side of the grill is lifted at an angle to the horizontal.

11. A barbecue grill comprising:
a grill body having front, rear, and side portions;
a grilling surface carried by said grill body;
a support base attached to said grill body;
a pair of interchangeable side platforms removably attached to the side portions of said grill body; and
at least one side burner incorporated into one of said interchangeable side platforms;
wherein said side burner and accompanying side platform may be detached from one side of said grill body and reattached to the other side of said grill body.

12. The barbecue grill of claim 11, wherein said side platform having said side burner incorporated therein further comprises at least one control knob for controlling the operation of said side burner.

13. The barbecue grill of claim 11 further comprising a hood pivotally attached to said grill body by at least one hinge, wherein said hinge comprises a pair of integral posts and a pair of corresponding mating tabs.

14. The barbecue grill of claim 11 further comprising:
at least one pair of wheels located on said support base; and
a support foot located proximate to said wheels;
wherein said support foot prevents said wheels from engaging the ground when said grill is in a sitting horizontal position, but allows said wheels to engage the ground when one side of the grill is lifted at an angle to the horizontal.

15. The barbecue grill of claim 11 further comprising:
a control panel located on the front of said grill for controlling the operation of said grilling surface of said grill; and
a grease pan removably incorporated into the underside of said control panel for capturing grease from said grill body.

16. A barbecue grill comprising:
a grill body having front, rear, and side portions;
a grilling surface carried by said grill body;
a support base attached to said grill body;
at least one pair of wheels located on said support base; and
at least one support foot located proximate to said wheels;
wherein said support foot prevents said wheels from engaging the ground when said grill is in a sitting horizontal position, but allows said wheels to engage the ground when one side of the grill is lifted at an angle to the horizontal.

17. The barbecue grill of claim 16 further comprising a hood pivotally attached to said grill body by at least one hinge, wherein said hinge comprises a pair of integral posts, and a pair of corresponding mating tabs.

18. The barbecue grill of claim 17 further comprising:
a pair of interchangeable side platforms removably attached to the side portions of said grill body; and
at least one side burner incorporated into one of said interchangeable side platforms;
wherein said side burner and accompanying side platform may be detached from one side of said grill body and reattached to the other side of said grill body.

19. The barbecue grill of claim 18, wherein said side platform having said side burner incorporated therein further comprises at least one control knob for controlling the operation of said side burner.

20. The barbecue grill of claim 16 further comprising:
a control panel located on the front of said grill for controlling the operation of said grilling surface of said grill; and
a grease pan removably incorporated into the underside of said control panel for capturing grease from said grill body.
